(19) United States
(12) Patent Application Publication
(10) Pub. No.: US 2015/0165651 A1
(43) Pub. Date: Jun. 18, 2015

(54) Method for Processing Single Nylon 6 Composites

(71) Applicants: Georgia Tech Research Corporation, Atlanta, GA (US); HS R & A CO., LTD, Gyeongsangnam-do (KR)

(72) Inventors: Donggang Yao, Lilburn, GA (US); Youjiang Wang, Atlanta, GA (US); Minsu Park, Gyeongsangnam-do (KR); Kyonghoon Cho, Gyeongsangnam-do (KR); Fangbing Lv, Atlanta, GA (US); Pipo Ma, Atlanta, GA (US); Shipeng Zhu, Atlanta, GA (US)

(73) Assignees: Georgia Tech Research Corporation, Atlanta, GA (US); HS R & A CO., LTD, Gyeongsangnam-do (KR)

(21) Appl. No.: 14/412,950

(22) PCT Filed: Jul. 2, 2013
(86) PCT No.: PCT/KR2013/005867

§ 371 Date: Jan. 5, 2015

Related U.S. Application Data
(60) Provisional application No. 61/668,208, filed on Jul. 5, 2012.

(51) Int. Cl. B29C 35/02; B32B 27/12; B32B 5/00

(52) U.S. Cl. CPC B29C 35/02; B32B 5/00; B32B 27/12; B32B 2305/08; B29K 2086/00

(57) ABSTRACT

The present invention relates to a method for reactively processing single nylon 6 composites. The processing method forms nylon 6 matrix over nylon 6 reinforcement by using anionic ring-opening polymerization of caprolactam.

### TECHNICAL FIELD

The present invention relates to a method for reactively processing single nylon 6 composites. The processing method forms nylon 6 matrix over nylon 6 reinforcement by using anionic ring-opening polymerization of caprolactam.

The single nylon 6 composites processed according to an exemplary embodiment of the present invention have a unique interfacial physical structure, excellent interfacial compatibility, improved mechanical strength and toughness while generally maintaining the mechanical properties of nylon 6 reinforcement.

### BACKGROUND ART

Single-polymer composites (SPCs) are composites with matrix and reinforcement (primarily fibrous material) made from the same polymer. Because a single polymer is employed, SPCs hold the promise for excellent mechanical properties (due to good chemical/physical compatibility at the fiber-matrix interface), light weight, and enhanced recyclability. Although the original concept of SPCs was proposed more than three decades ago by Capiati and Porter [N. J. Capiati and R. S. Porter, “Concept of one polymer composites modeled with high-density polyethylene”, J. Mater. Sci., 10: 1671-1677 (1975)], the progress in SPCs processing has been rather slow. So far, the work in SPCs manufacturing has been focused mostly on a fiber hot compaction process, where polymer fibers are compacted at a temperature very close to, but below, the polymer melting temperature so as to partially melt the fiber and fuse them into a single solid material. The major challenge in this process is the small difference, typically less than 5° C., between the feasible processing temperature and the fiber melting temperature. Within such a small temperature window, it is difficult to process the SPC under normal processing conditions without significantly annealing the fiber. It is known that polymer fibers annealed at a temperature close to their melting temperature results in a much reduced modulus toward that of the unoriented polymer.

Nylon 6 or polycaprolactam is a thermoplastic polymer formed by ring-opening polymerization. In the polymer/plastics industry, it is typically processed by melting processes including injection molding and extrusion into solid plastic articles. Research has also been reported on preparation of single nylon 6 composites using the hot compaction method [C. Bhattacharyya, P Maitrot, and S. Fakirov, “Polyamide 6 single polymer composites”, eXPRESS Polymer Letters, 3: 525-532 (2009)]. In this process, high tenacity nylon 6 yarn and nylon 6 film with slightly different melting temperatures are layered and then compression molded at 200° C. for 5 min followed by cooling. The nylon 6 SPC prepared by this method showed some improvement in mechanical properties over non-reinforced nylon 6. Limitations of this method include the difficulty in molding complex shapes, poor fiber and matrix mixing, undesired deformation of fibers during compression, long time in preparing the lamination, significant annealing of nylon 6 fiber at high temperature, among others. The hot compaction method has also been used to process recycled nylon 6 fabrics into a single polymer composite.

Nylon 6 may also be processed reactively starting from caprolactam. This approach has been used to prepare nylon 6 matrix composites. U.S. Pat. No. 5,424,388 disclosed a pultrusion process for long fiber-reinforced nylon 6 composites. A low-viscosity reaction mixture primarily made of molten caprolactam is charged into a closed impregnating tank to impregnate preheated and dried reinforced fibers, which is immediately pulled into a hot mold for composite molding processing to form a finished product of long fiber reinforced nylon 6 composites. U.S. Pat. No. 6,344,160 B1 disclosed a method for reactively processing short fiber reinforced nylon 6 composites by mixing reactive caprolactam resin with short reinforcing fibers and subsequently filling into mold cavity for curing. More recently, investigators from Netherlands developed a vacuum infusion process using reactive caprolactam mixture as the infusion resin and glass or carbon fabric as reinforcement [K. van Rijswijk, J. J. E. Teuwen, H. E. N. Bersee, and A. Beukers, “Textile fiber-reinforced anionic polyamide-6 composites. Part I: The vacuum infusion process”, Composites: Part A, 40: 1-10 (2009)].

However, in all these investigations, the reinforcement and the matrix are made of different materials, and the resulting composite is not a single polymer composite.

In another work to be noted, resin transfer molding was used to inject molten caprolactam reactive mixture into mold cavity placed with nylon 6.6 fabrics and form an all-polyamide composite. However, in this case, the resulting composite is not a genuine single-polymer composite either since nylon 6.6 has a different chemical structure and different physical properties from nylon 6 including melting temperature and crystallization kinetics.

### DISCLOSURE OF INVENTION

### Technical Problem

The main objective of this invention is to provide a reactive processing method for manufacture of single nylon 6 composites.

A second objective is to develop a low-viscosity processing method that can be easily used to wet and impregnate nylon 6 fibers in single polymer composites processing.

Another objective is to develop a method for processing single nylon 6 composites with a large processing temperature window.

Still another objective is to develop a processing protocol for protecting nylon 6 fibers from deterioration of mechanical properties during single polymer processing.

Still another objective of this invention is to produce single nylon 6 composites with a unique fiber-matrix interface suitable for enhanced interfacial compatibility.

A further objective is to provide a cost-effective method for producing nylon 6 composites with comparable mechanical strength and higher toughness compared with short glass fiber reinforced nylon 6 composites.

### Solution to Problem

In order to achieve the above objects, the present invention provides a method for reactively processing single nylon 6 composites by forming nylon 6 matrix over nylon 6 reinforcement through anionic ring-opening polymerization of caprolactam (8-caprolactam), and single nylon 6 composites processed thereby.

In more detail, the method for reactively processing single nylon 6 composites includes the steps of:

filling respectively a first vessel 10 with a first mixed resin including a molten caprolactam and an initiator, and a second vessel 12 with a second mixed resin including a molten caprolactam and an activator;

heating the first vessel 10 and the second vessel 12 in a vacuum state or an oxygen free environment;

delivering the first mixed resin and the second mixed resin respectively in the first vessel 10 and the second vessel 12 to a third vessel 14;

obtaining a third mixed resin by stirring the resins delivered to the third vessel 14;

delivering the third mixed resin of the third vessel 14 into a mold 16 cavity having a nylon 6 reinforcement 18 disposed thereinto; and

performing an anionic polymerization of the third mixed resin combined with the nylon 6 reinforcement 18 in the mold 16, wherein the temperature of the mold 16 is adjusted at 130° C. to 190° C.

### Advantageous Effects of Invention

The method for reactively processing single nylon 6 composites according to an exemplary embodiment of the present invention reduces reaction time, and can easily be applied to volume production. Further, during anionic polymerization of nylon 6 at temperature below the melting temperature of nylon 6, crystallization is a concurrent process during polymerization. Therefore, the nylon 6 fiber may work as a crystalline seed or template for the formation of a unique interfacial physical structure at the fiber-matrix interface. Further, due to the same chemical structure between the matrix and the fiber, a more compatible fiber-matrix interface is anticipated. Further, effects of improving mechanical strength and toughness can be achieved, generally maintaining mechanical properties of nylon 6 such as heat-resisting property.

### BRIEF DESCRIPTION OF DRAWINGS

FIG. 1 is a schematic drawing showing reactive processing of single nylon 6 composites by vacuum infusion according to an exemplary embodiment of the present invention.

FIG. 2 is a drawing showing a design of process setup for laboratory preparation of single nylon 6 composites according to an exemplary embodiment of the present invention.

FIG. 3 is a drawing showing an example of mold for vacuum infusion of molten caprolactam into nylon 6 fabric placed in the mold cavity.

### MODE FOR THE INVENTION

Hereinafter, the present invention is described in detail.

In an exemplary embodiment of the present invention, a method for reactively processing single nylon 6 composites includes the steps of:

filling respectively a first vessel 10 with a first mixed resin including a molten caprolactam and an initiator, and a second vessel 12 with a second mixed resin including a molten caprolactam and an activator;

heating the first vessel 10 and the second vessel 12 in a vacuum state;

delivering the first mixed resin and the second mixed resin respectively in the first vessel 10 and the second vessel 12 to a third vessel 14;

obtaining a third mixed resin by stirring the resins delivered to the third vessel 14;

delivering the third mixed resin of the third vessel 14 into a mold 16 cavity having a nylon 6 reinforcement 18 disposed thereinto; and

performing an anionic polymerization of the third mixed resin combined with the nylon 6 reinforcement 18 in the mold 16, wherein the temperature of the mold 16 is adjusted at 130° C. to 190° C.

The caprolactam (C6H11ON), also called ε-caprolactam, is a white, hygroscopic monomer with a melting temperature around 68° C.

The reactive processing method may be performed by using liquefaction technologies such as vacuum infusion, extrusion, pertrusion, spray up, and wet layer-up.

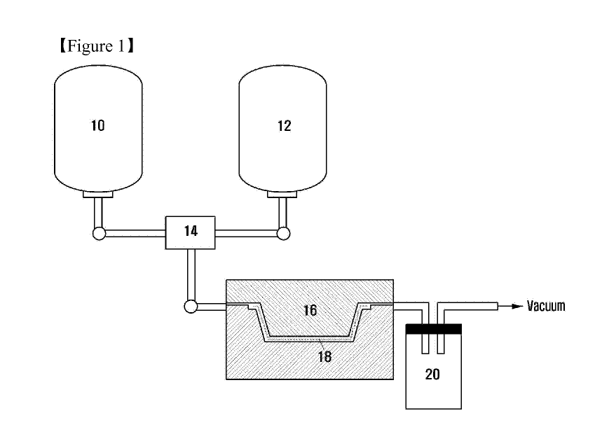

FIG. 1 shows a schematic setup for reactive processing of single nylon 6 composites by vacuum infusion. Hereinafter, the present invention is described in detail referring to FIG. 1, however the process according to the present invention is not limited to the vacuum infusion.

A first vessel 10 stores molten caprolactam with an initiator, and a second vessel 12 stores molten caprolactam with an activator.

The initiator and activator may be one conventionally used in the field of anionic ring-opening polymerization of nylon 6. For example, sodium caprolactamate, caprolactam magnesium bromide, or their combinations may be used as an initiator; however the initiator is not limited to the above chemicals. Further, N-acylcaprolactam, N-carbamoyllactams (for example, hexamethylene-1,6-dicarbamoylcaprolactam), or their combinations may be used as an activator; however the activator is not limited to the above chemicals.

In the exemplary embodiment of the present invention, it is also possible to incorporate reactive agents into the first vessel 10 and the second vessel 12 to create an initiator and an activator directly inside the vessel. For example, sodium hydride, sodium hydroxide, sodium methoxide, or their combinations can be added into the first vessel 10 to create some sodium caprolactam inside the vessel and use it as an initiator. Similarly, isocynate or other suitable cynates can be directly added into the second vessel 12 to create some carbamoyl caprolactam inside the vessel and use it as an activator. The first vessel 10 and the second vessel 12 may be used as heating tanks; however the present invention is not limited to this.

The first mixed resin and the second mixed resin are delivered respectively from the first vessel 10 and the second vessel 12 to a third vessel 14, forms third mixed resin in the third vessel 14 by stirring or other means of mixing, and the third mixed resin is delivered into a mold 16. As the third vessel 14, a mixing head may be used as shown in FIG. 1 or a mixing tank may be used; however the present invention is not limited to this.

Inside the mold 16, nylon 6 reinforcement 18 is deposited in advance of delivering the third mixed resin. The nylon 6 reinforcement 18 may have different physical forms such as a continuous fiber (long fiber), discontinuous fiber (short fiber), fabrics, tapes, and preforms. The mold 16 is preferably a moisture and oxygen free mold; however the mold is not limited to this. Anionic ring-opening polymerization is conducted inside the mold 16, leading to the production of a single nylon 6 composite material. A tank 20 represents a resin trap which stores residue flowing out from the mold 16.

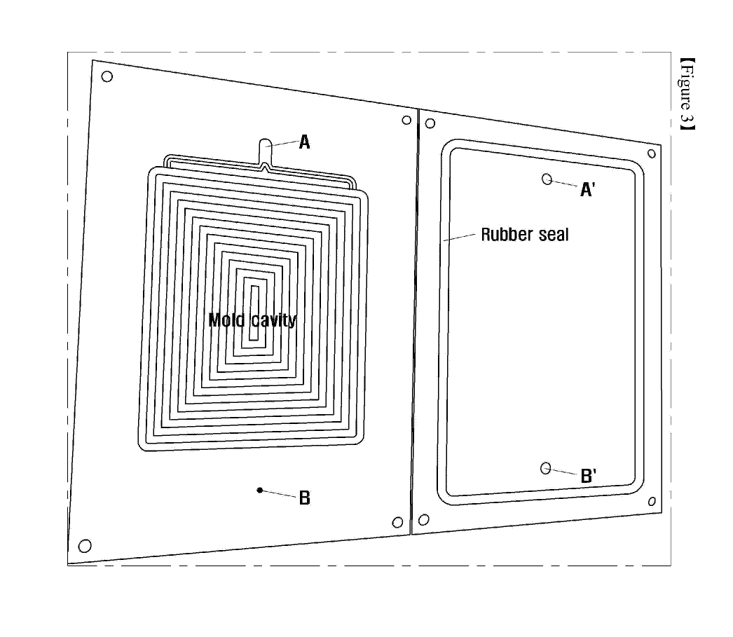

FIG. 3 is showing an example of mold for vacuum infusion of molten caprolactam into nylon 6 fabric placed in the mold cavity. After the mold closes, Location A mates with Location A′ and location B mates with Location B′. The caprolactam resin enters the mold cavity through the port at Location A′. The vacuum is taken through the port at Location B′.

The adjustment of processing parameters particularly temperature and time is critical for successful production of the single nylon 6 composite. A moisture and oxygen free environment is generally needed. For this purpose, both the first and second vessels 10 and 12 can be filled with dry nitrogen gas in the void space, and the mold 16 may be placed inside a nitrogen chamber. In general, the temperature of the mold is higher than that of the two vessels. The higher temperature facilitates higher reaction rate. This is desired in volume production of single nylon 6 composites.

The temperature of the mold 16 is essentially to be lower than the melting point of nylon 6, and nylon 6 matrix is formed by anionic ring-opening polymerization at a temperature lower than the melting point of nylon 6. In more detail, the melting point of nylon 6 is about 220° C.; therefore the temperature of the mold 16 is preferably 130° C. to 190° C., and more preferably 140° C. to 180° C.

Further, the temperatures of the first vessel 10 and the second vessel 12 may be 90° C. to 150° C., preferably 100° C. to 110° C., and more preferably 110° C. If the temperature exceeds the above range, problems can be generated due to premature reaction. If the temperature is lower than the above range, a problem deteriorating the quality of mixing can be generated due to slow reaction. The temperature of the third vessel 14 may be 90° C. to 150° C., and preferably lower than 100° C. so that polymerization is performed after sufficient molding of the third mixed resin with an enough time by avoiding the start of polymerization before introducing the third mixed resin into the mold 16.

Delivering the third mixed resin into the mold 16 may be performed by a vacuum pump; however the present invention is not limited to this. The delivering of the third mixed resin may be performed by pressure injection, gravity casting, centrifugal casting, or other molding and casting processes. In the case of delivering the third mixed resin into the mold 16 by casting or injection, the temperature of the third vessel 14 may be 100° C. to 150° C., and maintaining the temperature at the high end (towards 150° C.) is sometimes preferable for speedy polymerization.

In another exemplary embodiment of the present invention, if short processing time is not a main concern, one may also adjust the procedure for preparing the reactive fluid. For example, one may eliminate the second vessel 12 and directly introduce the activator into the third vessel 14.

In the exemplary embodiment of the present invention, the nylon 6 reinforcement withstands the heat and chemical attack in the reactive caprolactam mixture (corresponds to the third mixed resin) in a wide temperature window from 80° C. to above 160° C. Accordingly, single polymer composites containing a nylon 6 reinforcement that maintains its high mechanical properties, can be formed by combining the nylon 6 reinforcement with molten caprolactam without significantly reducing the mechanical properties of the nylon 6 reinforcement due to annealing. Further, if the nylon 6 reinforcement is stretched along the fiber axis by applying a tensile force, the maximum of the temperature range may be increased close to the melting point of nylon 6, and thereby the adverse effect of annealing is reduced and it may be helpful for maintaining high mechanical properties in a high processing temperature.

Further, the nylon 6 reinforcement may be introduced into the mold 16 after mixing with the third mixed resin separately, and particularly nylon 6 cut in different lengths may used by mixing with molten caprolactam. In this case, the mixing of the nylon 6 reinforcement with the third mixed resin may be performed by disposing the nylon 6 reinforcement in the third vessel 14 in advance.

The present invention relates to a method for reactively processing single nylon 6 composites and single nylon 6 composites processed thereby. However, engineers in composites processing may also elect to develop a hybrid reinforcing material that contains not only a nylon 6 reinforcing material but also other reinforcing materials such as glass fibers and carbon fibers. In a simple example, nylon fabrics and glass fabrics may be layered together or co-woven to form a single reinforcing material.

### Mode for Invention

Hereinafter, the present invention is described through the following experiment and exemplary embodiment. The experiment and exemplary embodiment is for describing the present invention in more detail, and thereby the present invention is not limited to the range of the following description.

Further, it should be understood that many variations and modifications of the basic inventive concept described herein will still fall within the spirit and scope of the present invention as defined in the appended claims.

Experiment 1: Experiments on single nylon 6 composites processing

Nylon 6 is synthesized from caprolactam (C6H11ON). There are a number of initiators and activators available for controlling the polymerization process of caprolactam. Particularly, with N-acyllactam as an activator and metal caprolactamate as an initiator, full conversion of caprolactam into nylon 6 can be completed in 3-60 minutes depending on the reaction temperature.

In this experiment, ε-caprolactam, an initiator Bruggolen® C 10 and an activator Bruggolen® C 20 P from Brueggemann Chemical were used for the polymerization process of ε-caprolactam into Nylon-6.

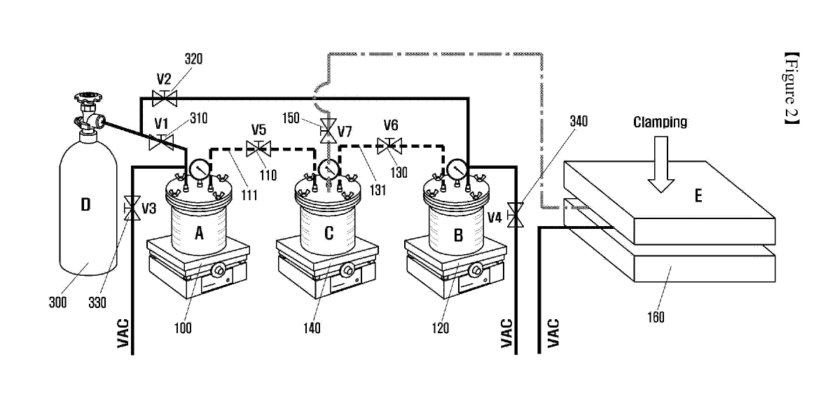

As shown in FIG. 2, the following 5 steps are used for fabricating a nylon 6 composite by resin infusion. The major components involved in this setup are A 100 (Heated tank for storing caprolactam and initiator), B 120 (Heated tank for storing caprolactam and activator), C 140 (Heated tank for caprolactam mixture from A 100 and B 120), D 300 (Dry nitrogen gas tank), and E 160 (Heated mold clamped between two platens of a heated Carver press).

Step 1: Fill tank A 100 to a half tank capacity with caprolactam and initiator, set heating temperature of tank A 100 to 110° C., close valves V1 310 and V5 110 and leave V3 330 open, and draw vacuum. Concurrently, half fill tank B 120 with caprolactam and activator and perform a mirror operation. Also make sure the ends of the pipes 111, 131 are all above the liquid resin level.

Step 2: Open V7 150 and draw vacuum.

Step 3: After 24-48 hrs of vacuum drying, shut off V3 330, slide the pipe 111 downward until it almost hit the bottom of tank A 100. Close V7 150. While V6 130 and V7 150 being closed, open V5 110. Adjust the output pressure of the nitrogen tank 300 and turn on V1 310. This leads to flow of the resin in tank A 100 into tank C 140. Perform a minor operation on B. More specifically, after 24-48 hrs of vacuum drying, shut off V4 340, slide the pipe 131 downward until it almost hit the bottom of tank B 120, and close V7 150. While V5 110 and V7 150 being closed, open V6 130. Adjust the output pressure of the nitrogen tank 300 and turn on V2 320 so that the resin in tank B 120 flows into tank C 140. Turn on the stirring unit on the heating plate for tank C 140 and ensure a good mixture of resin is produced in tank C 140. The temperature of tank C 140 should be set to below 100° C. so that the mixture can be used for a prolonged time for molding a number of parts.

Step 4: Prepare a vacuum infusion mold with nylon 6 fibers inside the mold cavity and clamp it between two heated platens on a heated Carver press 160. The mold temperature should set between 130° C. and 190° C. While V7 150 remains closed, run vacuum for a sufficiently long time to ensure any moisture in the mold cavity is evacuated. Then turn on V7 150 for resin infusion. When the cavity is filled, turn off V7 150 and keep the vacuum on until reaction is sufficiently conducted. A picture of the mold used for resin infusion of molten caprolactam into nylon 6 fabrics placed in the mold cavity is shown in FIG. 3.

Step 5: Perform mold opening and part ejection.

When the above-described five steps were completed, single nylon 6 composites were successfully prepared. The results showed that nylon 6 fibers can withstand the heat and chemical attack in the reactive caprolactam mixture (corresponds to third mixed resin) in a wide temperature window from 80 to above 160° C.

For anyone experienced in composites processing or polymer processing, it is obvious to scale up the process of Experiment 1 for large scale production. For example, one may premix nylon 6 fibers chopped in discrete length (as short or long fibers) with molten caprolactam and then use an injection process for filling a mold cavity Likewise, it also becomes apparent to modify the techniques for drying caprolactam, mixing the reaction liquid, and infusing or injecting the resin for large scale production.

1. A method for reactively processing single nylon 6 composites, comprising the steps of:
(a) filling respectively a first vessel with a first mixed resin including a molten caprolactam and an initiator, and a second vessel with a second mixed resin including a molten caprolactam and an activator;
(b) heating the first vessel and the second vessel in a vacuum state;
(c) delivering the first mixed resin and the second mixed resin respectively in the first vessel and the second vessel to a third vessel;
(d) obtaining a third mixed resin by stirring the resins delivered to the third vessel;
(e) delivering the third mixed resin of the third vessel into a mold cavity having a nylon 6 reinforcement disposed thereinto; and
(f) performing an anionic polymerization of the third mixed resin combined with the nylon 6 reinforcement in a mold, wherein the temperature of the mold is adjusted between 130° C. and 190° C. in the mold.

2. The method of claim 1, wherein the heating temperature of the first and second vessel at step (b) is adjusted between 90° C. and 150° C.

3. The method of claim 1, wherein the heating temperature of the mixing tank at step (c) is adjusted between 90° C. and 150° C.

4. The method of claim 1, wherein the reactive processing is performed in a nitrogen atmosphere.

5. The method of claim 1, wherein the nylon 6 reinforcement is selected from a group consisting of continuous fibers, discontinuous fibers, fabrics, tapes, and preforms.

6. The method of claim 1, wherein the nylon 6 reinforcement is a fibrous material processed by stretching along a fiber axis.

7. A single nylon 6 composite fabricated by a method according to claim 1.
